(19) United States
(12) Patent Application Publication
(10) Pub. No.: US 2026/0297891 A1
(43) Pub. Date: Oct. 1, 2026

(54) MACHINE FOR REMOVING SEDIMENT, DREGS, AND THE LIKE

(71) Applicant: GEROTTO FEDERICO S.R.L., CAMPODARSEGO (PADOVA) (IT)

(72) Inventors: Alessandro GEROTTO, CAMPODARSEGO (PADOVA) (IT); Roberto GEROTTO, CAMPODARSEGO (PADOVA) (IT); Alberto FELETTO, GAIARINE (TREVISO) (IT)

(73) Assignee: GEROTTO FEDERICO S.R.L., CAMPODARSEGO (PADOVA) (IT)

(21) Appl. No.: 19/163,218

(22) PCT Filed: Dec. 13, 2023
(86) PCT No.: PCT/EP2023/085559

§ 371 Date: Sep. 8, 2025

(30) Foreign Application Priority Data
Mar. 10, 2023 (IT) 102023000004500

(51) Int. Cl. E02F 3/88; B08B 9/093; E02F 3/92

(52) U.S. Cl. CPC E02F 3/8816; B08B 9/0933; E02F 3/9218

(57) ABSTRACT

A machine for removing sediments, dregs and the like, having a self-propelled machine body, with which is associated at least one suction mouth of a material to be removed that is fluidically connected to an outflow duct of the removed material, which in turn is fluidically connectable to a storage site located in a remote position with respect to the machine; the machine has a recirculation means mounted on the machine body and configured to reuse at least part of the removed material that passes through the outflow duct to erode and break up the material to be removed.

The present invention refers to a machine for removing sediment, dregs and the like intended, in particular, to perform cleaning and restoration operations in tanks and cisterns used for storing petroleum products and/or chemical products.

As is known, fluid storage tanks used in the oil industry and in the chemical industry are periodically subjected to cleaning operations.

In fact, inside such fluid storage containers an accumulation of mud tends to occur near or at the bottom, as a result of the slow sedimentation of products with high gravity.

This can give rise to a variety of problems, including, for example, a reduction in container capacity, the onset of corrosion phenomena, and others.

In this regard, various systems are therefore used to carry out the necessary cleaning operations.

Among the known cleaning systems, so-called ‘no-man-entry’ technologies are becoming increasingly popular, whereby the necessary operations are carried out without personnel operating inside the storage containers.

No-man-entry technologies for cleaning tanks and cisterns with white oil and black oil are relatively recent and, together with robotic systems, offer an alternative to traditional cleaning methods, which involved manpower having to enter the tanks and remove sediment and sludge, or other technologies involving the use of automated recirculation systems for sludge dissolution, suction and separation of solid materials from hydrocarbons.

The robotic systems currently available essentially involve the use of a special robotic machine designed to enter inside the fluid storage container, an external control unit, an external power unit and an external suction unit, such as for example a centralized vacuum cleaner or a purge truck.

However, it should be noted that through a self-purge, a pneumatic conveyance of the material is performed, i.e. the material is dragged through the pipe by the velocity of the air until the maximum vacuum limit of 0.8 bar is reached; with viscous fluids, the material tends to stick and stop in the pipe.

So, in fact, vacuum technology needs to transform the mud into liquid in order to enable its transfer, but this comes up against obvious problems of waste generation.

Alternatively, it is possible to install a positive displacement pump on board the robotized machine; this type of pump allows the mud to be transferred as it is, but its air suction capacity is considerably lower and therefore the supply of the material to its suction mouth is essential.

It should also be considered that the material to be removed may be extremely compact, such that it often requires the dispensing of water or appropriate solvents, generally substances of the same nature as the product contained in the tank, which serve to make the mud more fluid in order to facilitate its suction by the pump.

Those solvents, which can also be distributed in large quantities, must then be collected and properly recovered both in order to contain costs and in order to protect the environment by avoiding their dispersion.

U.S. Pat. No. 5,561,883A discloses a cleaning system for cleaning storage containers used in petrochemical or oil refineries. A remotely controllable dual tracked robotic vehicle is placed in a container to be cleaned. A cleaning fluid diluent material is directed against waste material in the container causing a portion of it to form a slurry which is vacuumed out by a nozzle and hose carried by the vehicle. A separator system exterior to the tank processes the removed slurry.

JPH06142626A discloses a sludge eliminating device in tank. The device has a carriage running on the bottom face, a cover, which is attached to the front part of the carriage and whose front and lower part are opened, an impeller which is supported so as to be rotatable in the inside of the cover and scrapes off sludge, and a treating liquid supply hose for supplying a treating liquid for melting the sludge to a blade through a hollow axle of the impeller. The device also has a molten sludge suction tube which is attached to the carriage, whose tip part is positioned in the rear of the impeller, and which has a bell-mouth in its tip part, a pump loaded on the carriage for connecting the suction tube to a suction port, and a molten sludge discharge tube connected to a discharge port of the pump.

The aim of the present invention is to provide a machine for the removal of sediment, dregs, and the like, that overcomes the drawbacks of the cited prior art and allows to eliminate, or at least limit, the use of externally-introduced solvents during tank cleaning.

Within the above aim, a particular object of the invention is to provide a machine that is able to recover part of the substances already present inside the tank for self-sustaining the cleaning process.

A further object of the invention is to provide a machine that makes it possible to avoid waste, so that its use is advantageous from an economic viewpoint as well.

A further object of the invention is to provide a machine that improves the efficiency of the cleaning process and simultaneously reduces the environmental impact.

A further object of the invention is to provide a machine that is compact enough to fit into a tank through a manhole.

A further object of the invention is to provide a machine that can operate even in the presence of explosive atmospheres.

This aim and objects, as well as others which will become better apparent below, are achieved by a machine for removing sediments, dregs, and the like, as claimed in the appended claims.

Further features and advantages will become better apparent from the description of a preferred, but not exclusive, embodiment of a machine according to the invention, illustrated by way of non-limiting example in the accompanying drawings, wherein:

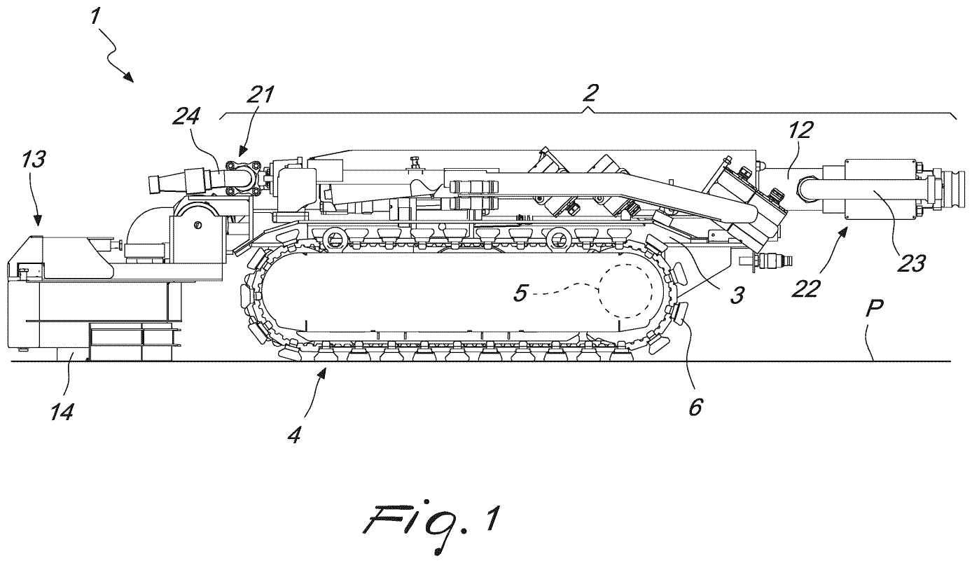

FIG. 1 is a side view of the machine according to the invention;

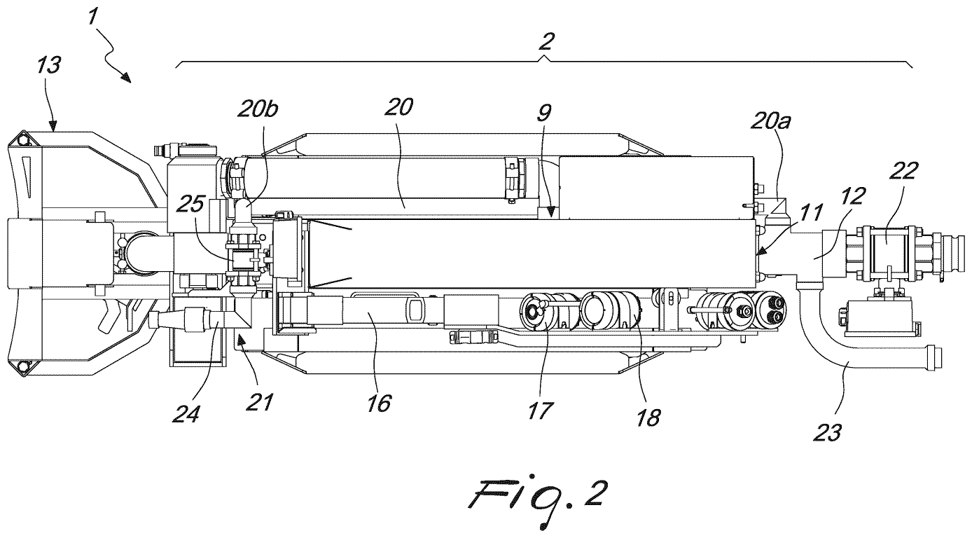

FIG. 2 is a top view of the machine according to the invention;

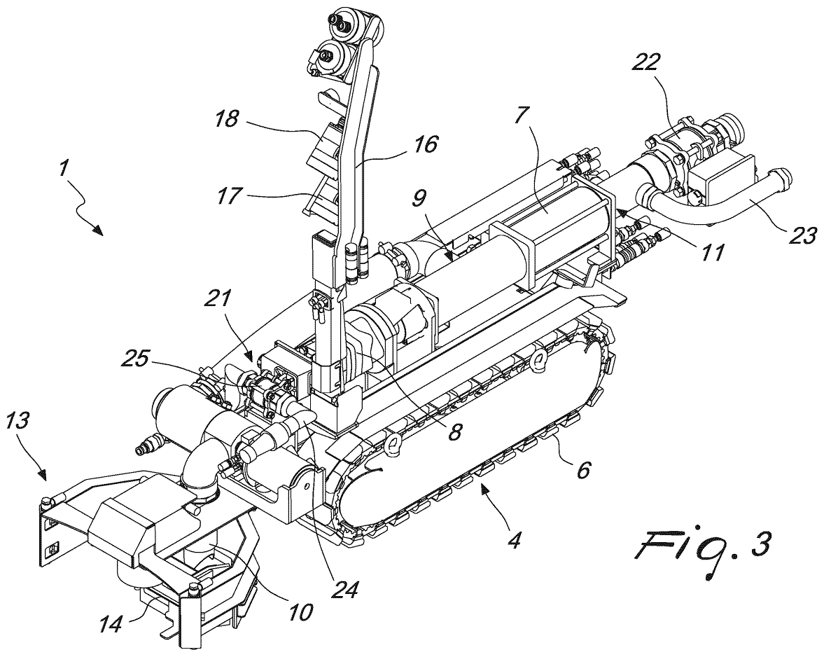

FIG. 3 is a perspective view of the machine according to the invention;

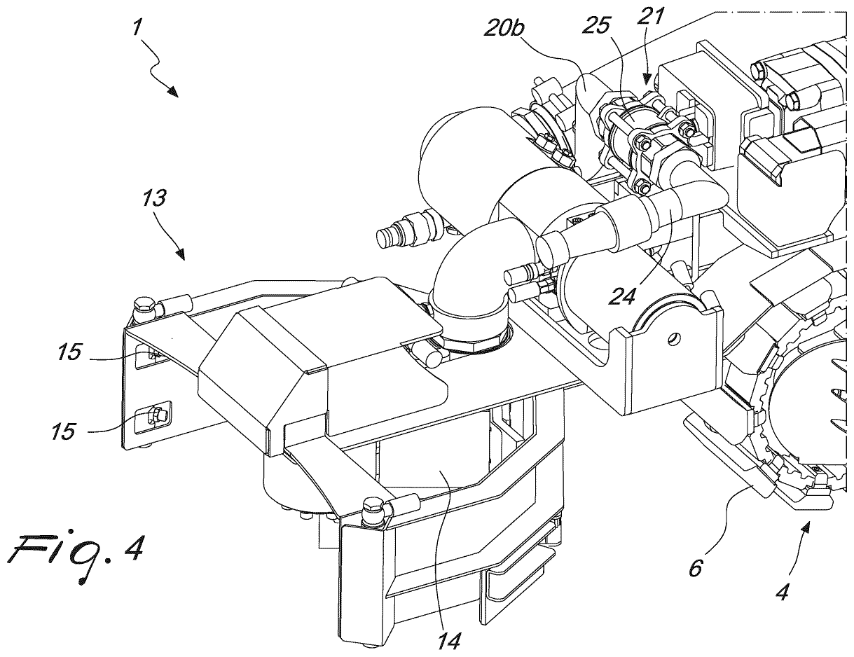

FIG. 4 is a perspective detailed view illustrating the front portion of the machine according to the invention;

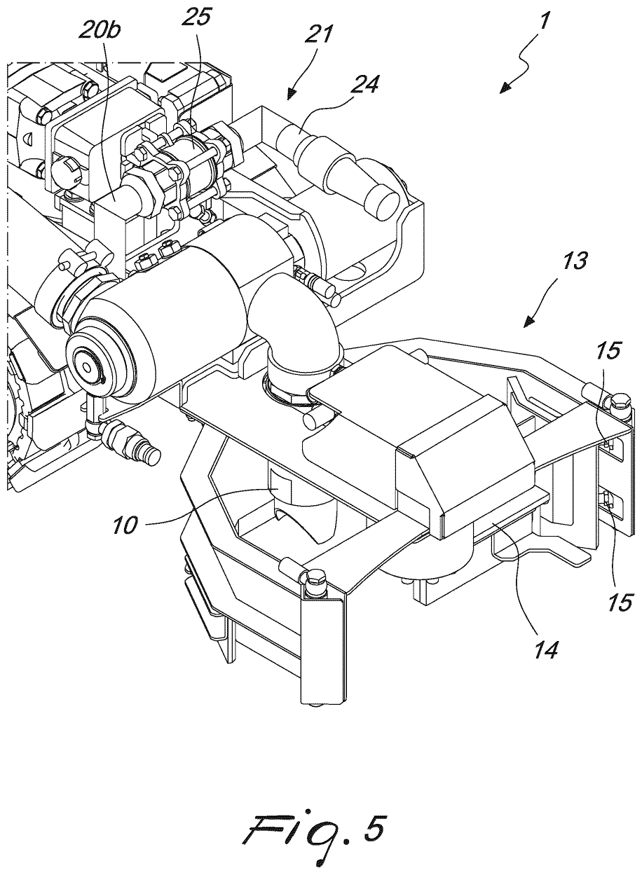

FIG. 5 is another perspective view showing detailing the front portion of the machine according to the invention;

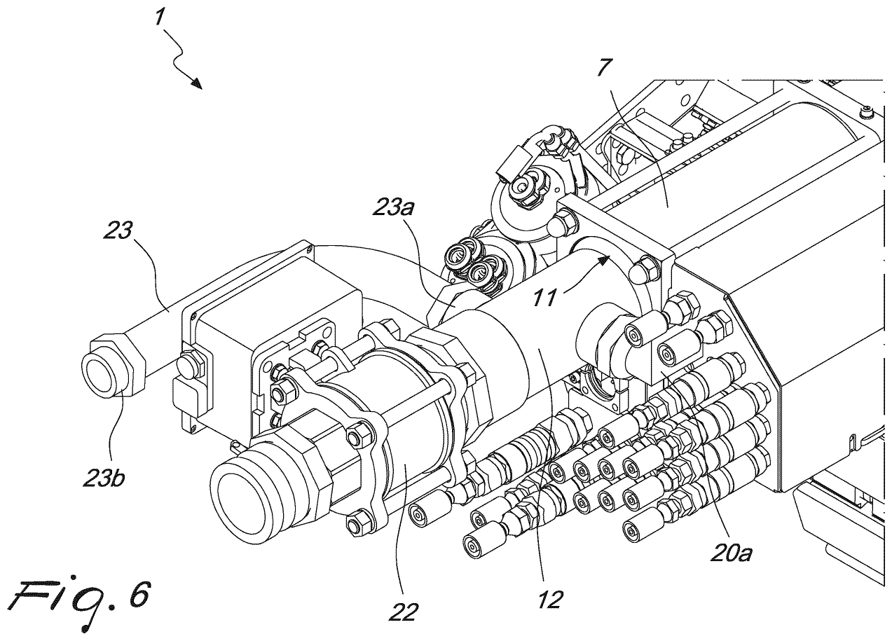

FIG. 6 is a perspective view showing the rear portion of the machine according to the invention.

With reference to the figures, a machine for removing sediments, dregs and the like is generally indicated by the reference numeral 1.

The machine 1 is particularly designed to perform cleaning operations in confined spaces, such as tanks and cisterns for the storage of petroleum products, without the assistance of operating personnel inside them, thus constituting a de facto no-man-entry technology.

For this purpose, the machine 1 is fully remote-controlled and controlled by means of an umbilical system, not illustrated, consisting of a bundle of connections providing both the fluidic and electrical power supply, and the commands to actuate the various functions and sensors installed on the machine 1.

In addition, the machine 1 is designed to be able to operate in environments at risk of explosion, e.g. in areas classified according to ATEX regulations as zone 0.

It will be apparent to the person skilled in the art that the machine 1 is also suitable for uses other than those indicated above, without thereby falling outside the scope of protection of this patent.

The machine 1 has a machine body 2 comprising a frame 3 having motion means 4 allowing the machine 1 to move above a supporting plane P, consisting, for example, of a bottom area of a tank or of a cistern.

In this illustrated example, the handling means 4 comprise a pair of fluidic motors 5 driving a respective pair of tracks 6, preferably of the magnetic type, positioned on opposite sides of the machine body 2.

A pumping device 7 is mounted on the frame 3, and is designed to vacuum material to be removed that has been deposited on the supporting plane P.

This material may be in solid, liquid or semi-solid form, and may consist, for example, of oily dregs formed from solid particles, crude oil and water.

The pumping device 7 is a positive displacement pump, preferably a progressive cavity pump, driven by a fluidic motor 8.

The pumping device 7 has a suction member 9 fluidically connected to a suction mouth 10 of the material to be removed, and a delivery member 11 fluidically connected to an outflow duct 12 of the removed material.

The outflow duct 12 is located at a rear part of the machine 1 and is arranged to be fluidically connected to a storage site of the removed material, located in a remote position with respect to the machine 1.

Preferably, the transfer of the removed material from the machine 1 to the remote storage site takes place through a flexible pipe, not shown, integrated into the umbilical system.

Advantageously, a supply device 13, for the material to be removed, is mounted on a front part of the machine 1, which is preferably movably connected to the machine body 2 and can be positioned in an adjustable manner with respect to the support plane P.

In this embodiment, the supply device 13 is equipped with an oscillating tool 14 which can be selectively activated in rotation with reciprocating motion around its own axis of rotation.

It will be apparent to the person skilled in the art that the machine can be fitted with a supply device different from the one here described and illustrated; the machine may also have no supply device.

Preferably, one or more delivery nozzles 15, in this case two on each side, are arranged on the supply device 13 and are adapted for spraying towards the suction mouth 10 and/or towards the material to be removed jets of a treatment fluid, preferably consisting of water and/or a hydrocarbon-based solvent.

Advantageously, a lifting arm 16 hinged to the machine body 2 and equipped with visual acquisition means is mounted on the machine 1. The visual acquisition means may be a video camera 17 and at least one lighting device 18, configured to detect images from above of the environment surrounding the working/moving area of the machine 1.

According to the present invention, the machine 1 comprises recirculation means mounted on the machine body 2 and configured to reuse at least part of the removed material, that is passing through the outflow duct 12 and has not yet transferred to the storage site, in order to erode and break up the material to be removed which has deposited on the supporting plane P.

The machine 1 comprises a recirculation duct 20 having a first end 20a fluidically connected to the outflow duct 12 downstream of the pumping device 7, with respect to the flow of the removed material, and a second end 20b fluidically connected to delivery means 21 of the removed material, as described below.

A first valve means 22, e.g. a solenoid valve, is arranged along the outflow duct 12 downstream of the first end 20a of the recirculation duct 20, with respect to the flow of the removed material.

The first valve means 22 can be configured to selectively define at least one recirculation condition, in which at least part of the removed material passing through the outflow duct 12 is fed to the delivery means 21 by the pumping device 7, and an outflow condition, in which the removed material is transferred to the storage site.

Preferably, the machine 1 also comprises an additional duct 23 having a first end 23a fluidically connected to the outflow duct 12 downstream of the pumping device 7 but upstream of the first valve means 22, with respect to the flow of the removed material.

A second end 23b of the additional outflow duct 23 can be fluidically connected with supply means of the treatment fluid. In the recirculation condition, if necessary the treatment fluid is mixed in varying quantities with the removed material fed to the delivery means 21 by the pumping device 7.

A delivery means 21 is mounted at the front part of the machine 1. The delivery means 21 comprises at least one orientable nozzle 24 for delivering the removed material fluidically connected to the second end 20b of the recirculation duct 20.

The orientable nozzle 24 has the peculiarity of emitting the removed material with a jet directed substantially towards the material to be removed, in the area located in front of the supply device 13.

Preferably, a second valve means 25, e.g. a solenoid valve, is arranged immediately upstream of the orientable nozzle 24, with respect to the flow of said removed material.

The second valve means 25 is also configured to selectively define at least the recirculation condition and the outflow condition.

In the above described embodiment, the pumping device feeding the recirculation means is the same device used to vacuum the material to be removed and then discharge it to the storage site for the removed material.

It is apparent to the person skilled in the art, that the inventive concept of present invention generally refers to the recirculation means, and such inventive concept may be used in a variety of machines.

For example, according to an embodiment of the invention, the machine is configured to be connected to an external suction unit, such as for example a central vacuum cleaner or a purge truck.

A pumping device is therefore installed on board the machine body, and is essentially exclusively dedicated to the recirculation means.

In this case, the pumping device is preferably placed along the recirculation duct downstream of the first end of the latter, with respect to the flow of the removed material.

The operation of the machine 1 according to the present invention is apparent from the foregoing and is briefly described below.

The machine 1 is introduced through a manhole into a confined space, such as for example a tank containing the deposited material to be removed.

At this point, by means of a control panel placed outside the tank and connected via the umbilical system to the machine 1, the operator places the lifting arm 16 transversely to the supporting plane P and performs substantially all the necessary operations to make the machine 1 operational.

The supply device 13 is then activated, and dislodges and breaks up the material to be removed, assisted in its function by the nozzles 15, and conveys it to the suction mouth 10.

The dislodged material is then sucked up by the pumping device 7 and pumped continuously to a storage site of the removed material, located in a remote position with respect to the machine 1, or in any case outside the tank.

Thanks to the on-board pumping device 7, the machine 1 is able to pump the removed material even over long distances.

If the material to be removed proves to be excessively compacted and dry, or in any case needs to be made more fluid, the operator may decide to activate the recirculation means, using them at the same time or as an alternative to the supply device 13.

In practice, by bringing the first 22 and the second valve means 25 to the recirculation condition, the pumping device 7 pumps at least part of the removed material into the recirculation duct 20, thereby feeding the orientable nozzle 24, which emits this removed material with a jet directed substantially towards the material to be removed, in the area located in front of the supply device 13.

The removed material coming out under pressure from the orientable nozzle 24 then erodes and breaks up the material to be removed.

If necessary, the removed material pumped into the recirculation duct 20 can be mixed with a variable amount of treatment fluid fed through the additional duct 23.

Once its function is completed, the recirculation means is deactivated, bringing the first 22 and second valve means 25 to the outflow condition.

At the end of the cleaning operations, the lifting arm 16 is placed in a position substantially parallel to the supporting plane P and the machine 1 is placed in non-operational condition, after which it is removed from the tank.

According to the further embodiment mentioned above, when the first and second valve means are brought to the recirculation condition, the pumping device is also activated, whereas when the first and second valve means are brought to the outflow condition, the pumping device is deactivated.

In practice, it has been found that the invention achieves the aim and objects mentioned above with a machine for the removal of sediments, dregs and the like that greatly limits, if not completely eliminates, the use of externally-introduced solvents during tank cleaning operations.

In fact, thanks to the recirculation means, the machine according to the invention is able to recover part of the substances already present inside the tank for self-sustaining the cleaning process.

A further advantage of the invention is that this machine makes it possible to prevent waste, thus making its use particularly advantageous from an economic viewpoint as well.

A further advantage of the invention is an improved efficiency of the cleaning process and a reduction of the environmental impact.

A further advantage is constituted by the compact dimensions allowing the machine to enter a tank through a manhole, A further advantage of the invention is constituted by the technical features that enable the machine to operate even in the presence of explosive atmospheres.

This application claims the priority of Italian Patent Application No. 102023000004500, filed on Mar. 10, 2023, the subject matter of which is incorporated herein by reference.

We claim:

1. A machine for removing sediments, dregs and the like, comprising a self-propelled machine body (2); at least one suction mouth (10) of a material to be removed being associated with said body (2); said suction mouth (10) being fluidically connected to an outflow duct (12) of the removed material; said outflow duct (12) being fluidically connectable with a storage site located in a remote position with respect to said machine (1); said machine wherein it comprises recirculation means (20) mounted on said machine body (2) and configured to reuse at least part of the removed material that passes through said outflow duct (12), in order to erode and break up said material to be removed.

2. The machine according to claim 1, wherein said recirculation means comprises a recirculation duct (20) having a first end (20a) fluidically connected to said outflow duct (12), and a second end (20b) fluidically connected to delivery means (21) of said removed material onto said material to be removed; a pumping device (7) having a suction member (9) fluidically connected to said suction mouth (10) and a delivery member (11) fluidically connected to said delivery means (21), and first valve means (22) arranged along said outflow duct (12) downstream of the first end (20a) of said recirculation duct (20) with respect to the flow of said removed material; said first valve means (22) being configurable to selectively define at least one recirculation condition, in which at least part of the removed material that passes through said outflow duct (12) is fed to said delivery means (21) by said pumping device (7), and an outflow condition, in which said removed material is transferred to said storage site.

3. The machine according to claim 1, wherein said pumping device (7) is arranged along said outflow duct (12), upstream of the first end (20a) of said recirculation duct (20) with respect to the flow of said removed material.

4. The machine according to claim 1, wherein said pumping device (7) is arranged along said recirculation duct (20), downstream of the first end (20a) of said recirculation duct (20) with respect to the flow of said removed material.

5. The machine according to claim 1, wherein said delivery means (21) comprise at least one orientable nozzle (24) for delivery of said removed material with a jet substantially directed towards said material to be removed; said orientable nozzle (24) being fluidically connected to the second end (20b) of said recirculation duct (20).

6. The machine according to claim 5, wherein said delivery means (21) comprise second valve means (25) arranged immediately upstream of said orientable nozzle (24) with respect to the flow of said removed material; said second valve means (25) being configurable in order to selectively define at least said recirculation condition and said outflow condition.

7. The machine according to claim 1, further comprising an additional duct (23) having a first end (23a) fluidically connected to said outflow duct (12), upstream of said first valve means (22) with respect to the flow of said removed material, and a second end (23b) fluidically connectable to supply means of a treatment fluid.

8. The machine according to claim 1, further comprising one or more delivery nozzles (15) of a treatment fluid with respective jets directed substantially towards said suction mouth (10) and/or towards said material to be removed.

9. The machine according to claim 1, further comprising a supply device (13) of the material to be removed, connected to said machine body (2) and configured to dislodge said material to be removed and convey it towards said suction mouth (10).

10. The machine according to claim 1, further comprising a lifting arm (16) hinged to said machine body (2); said lifting arm (16) comprising visual acquisition means (17, 18) configured to detect images from above of the environment surrounding the working/moving area of said machine (1).
